(19) United States
(12) Patent Application Publication
(10) Pub. No.: US 2009/0095057 A1
(43) Pub. Date: Apr. 16, 2009

(54) INTEGRATED MICROFLUIDIC NOZZLE DEVICE FOR CHROMATOGRAPHIC SAMPLE PREPARATION FOR MASS SPECTROMETRY APPLICATIONS

(75) Inventor: Sau Lan Tang Staats, Hockessin, DE (US)

Correspondence Address: Leason Ellis LLP, 81 Main Street, Suite 503, White Plains, NY, 10601, US

(73) Assignee: Phoenix S&T, Inc., Chester, PA (US)

(21) Appl. No.: 12/251,670

(22) Filed: Oct. 15, 2008

Related U.S. Application Data
(60) Provisional application No. 60/980,343, filed on Oct. 16, 2007.
(60) Provisional application No. 60/984,906, filed on Nov. 2, 2007.

(51) Int. Cl. G01N 1/00; H01J 49/00

(52) U.S. Cl. 73/64.56; 250/281; 73/863

(57) ABSTRACT

In accordance with one aspect of the present invention, a low-cost injection-molded plastic microfluidic device that performs the multiplexing of affinity or chromatographic sample cleanup and enrichment methods and the detection by nanospray mass spectrometry of analytes such as biomarkers in a single package to conserve sample, and processes body fluids with HPLC grade and even next-generation chromatographic resins such as nanoparticles to maximize the sensitivity of the detection.

### CROSS-REFERENCE TO RELATED APPLICATIONS

The present application claims the benefit of U.S. Patent Application Nos. 60/980,343, filed Oct. 16, 2007 and 60/984,906, filed Nov. 2, 2007, each of which is hereby incorporated by reference in its entirety.

### BACKGROUND

Samples for mass spectrometry often need to be cleaned up or concentrated before being introduced into the mass spectrometer for analysis. The cleaning procedures are especially necessary for samples such as body fluids (blood serum, plasma, urine, bile, etc.) because of the complexity of the sample and the high likelihood that these samples will contaminate the mass spectrometers to the extent that lengthy down time results for cleanup in order to restore the spectrometer to a working condition. The concentration procedures are needed also for these samples because the existence of numerous other species in the sample can mask the ionization of the analyte of interest, a phenomenon known as ion suppression, or in some cases, the concentration of the analyte is simply too low for the detection limit of the mass spectrometer.

There are many different devices and methods known in the art for sample cleanup and concentration for mass spectrometry. However, for body fluids, fermentation broth, environmental samples, etc., the sample cleanup and concentration device cannot be used to introduce the sample into the mass spectrometer. The cleaned/concentrated sample has to be transferred to another device, e.g., a MALDI (matrix-assisted laser desorption and ionization) plate, or to a sample vial where the sample can be further transferred to a high performance liquid chromatography (HPLC) column that is connected to a mass spectrometer, or a syringe for direct infusion into the mass spectrometer. Moreover, the sample cleanup device is typically quite large, such as a pipette tip containing chromatographic silica particles because the body fluid will clog vessels with small bore such as a capillary with small internal diameters under 100 μm. Such a large device cannot effectively handle small amount of sample, e.g., a few microliters. Another popular method for sample cleanup is to modified the surface of a MALDI plate with chromatographic materials to make the surface hydrophobic, hydrophilic, etc. so that when a few microliters of the body fluid sample is placed on the chemically modified surface, molecules that have an affinity for that particular property, e.g. hydrophobic, hydrophilic, etc., will bind to the surface when the rest of the sample is washed off. The bound molecules are then laser desorbed and ionized with the help of matrix molecules into the mass spectrometer. This method is called surface-enhanced laser dissociation and ionization (SELDI). The sensitivity of this technique is limited because the binding area is restricted to a spot on the surface or the SELDI plate, and the body fluid is washed away after one kind of affinity binding.

High Performance Liquid Chromatography (HPLC) HPLC is used to separate components of a mixture by using a variety of chemical interactions between the substance being analyzed, or analyte, and the chromatography column. Since the column is at least a few cm's long and 50 μm in diameter, and packed with particles of a few μm in diameter or a porous resin with pores of micron and sub-micron sizes, the surface area for interacting with the analyte is much larger and therefore the sensitivity of detection for the analyte is much higher than in the case of SELDI. The end of the HPLC column is often connected to a spray device and the eluate from the column is ionized and sprayed in a process called electrospray or nano-electrospray (nanospray) into the mass spectrometer for detection. The eluate may also be spotted on a MALDI plate for MALDI mass spectrometry detection. HPLC, though powerful and can product high sensitivity detection, especially in the nanoLC and nanospray mass spectrometry format where concentration level of pg/mL may be obtained, requires extensive sample cleanup for body fluids or else both the column and the spray device may be clogged because of the complexity of the sample. For disease biomarkers detection in a clinical environment, the HPLC mass spectrometry is not practical.

A possible solution to creating a device for early-stage clinical detection of cancer biomarkers in body fluids with high sensitivity is through microfluidics. Microfluidics offers the possibility of simultaneous processing (multiplexing) of biomarkers using extremely small amount of sample in each process, thereby increasing the specificity of the disease diagnosis and also the throughput. The complexity of the tasks in clinical proteomics makes high-throughput and tasks integration very attractive. There are several formidable barriers for microfluidics to overcome before becoming applicable to clinical applications:
1. Conventional planar microfluidic devices with open channels designed for capillary electrophoresis may not have the resolution or capacity for the vast amount of materials in body fluid samples
2. Packing the conventional channel with a rectangular cross-section with chromatographic resins, especially the smaller particle sizes (5 μm or smaller) to take advantage of the existing methodology for sample cleanup and affinity chromatography has remained a challenge.
3. Interfacing the planar geometry of the devices with liquid dispensing robotics or mass spectrometry has been difficult and wrought with problems such as large dead volume and bulky connections.
4. The cost of manufacturing microfabricated glass or quartz devices, even if such a device can be designed for clinical proteomics, is high because of the expensive clean room techniques and instrumentation

### SUMMARY

The present invention described in this application is a low-cost injection-molded plastic microfluidic device that performs the multiplexing of affinity or chromatographic sample cleanup and enrichment methods and the detection by nanospray mass spectrometry of analytes such as biomarkers in a single package to conserve sample, and processes body fluids with HPLC grade and even next-generation chromatographic resins such as nanoparticles to maximize the sensitivity of the detection. Nanospray spotting of a MALDI plate may also be included in the protocol. Packing of resins into the single or multiple-channel device can be readily achieved through a novel constriction in the microfluidic channel that retains particles in the channel without a frit. In one embodiment of the invention, the microfluidic channel has a circular cross-section and is seamless. The constriction in the channel for retaining the chromatographic particles is conical in shape and the opening at the apex of the cone is ˜20 μm. Interfacing the device to sample and buffers inputs is through a simple insertion of the tubing or capillary from an external supply sources into one or more capillary input ports of the device without any bulky fitting and minimal dead volume. The device does not clog even with unprocessed but slightly diluted body fluids, e.g., 20 times dilution of serum or plasma. Creating valves to direct the flow of the fluid inside the device is also based on the insertion of a cylindrical piston or in some cases, a filled capillary, into the receptacle hole in the fluid channel. The device allows automated sample cleanup/processing and multiplexing for the detection for at least 5 biomarkers.

In one embodiment, this device overcomes all the shortcomings mentioned in the background. It can process body fluids without previous processing or with just dilution or filtering, and it can use free chromatographic particles down to a few microns in diameter, or immobilized particles down to nanometers in diameter, or polymeric monoliths, and can be used for spraying the eluate of the retained molecules directly into the mass spectrometer, or onto a MALDI plate. The device is also constructed so that down to one microliter of sample may be processed and sprayed effectively. Moreover, the device may be put in an array format such as a 96 or 384 well microtiter plate to take advantage of the robotic liquid dispensing equipment available for these formats so that the sample processing can be easily automated.

In another embodiment of the invention, the device can be made in the format of a conventional microfluidic channel device comprising of top and bottom substrates that are bonded to create an enclosed channel that has a constriction along the length of the channel. The top and bottom substrates may be made of glass, quartz, etc. but are preferably made by the injection-molding of plastic. The constriction in the channel may be a wedge-shaped channel along the length of a typical rectangular microfluidic channel. The size of the opening at the small end of the wedge may be 10 μm×10 μm.

In one embodiment, the method for preparing a sample for injection into a mass spectrometer for analysis includes the steps of: (a) forming an injection molded article that includes a body having a first surface and an opposing second surface, the body having at least one channel formed therein and extending through the body from the first surface to the second surface, wherein the channel has a reservoir section that is open at the first surface and a tapered section; and at least one nozzle disposed along the second surface and being in communication with the conical section, the nozzle being in fluid communication with the channel such that one end of the channel terminates in a nozzle opening that is formed as part of the nozzle, wherein the device is formed of an injection moldable material; and (b) filling the nozzle with chromatographic particles.

### BRIEF DESCRIPTION OF THE FIGURES

FIG. 1 is a schematic drawing of an integrated microfluidic device for chromatographic sample preparation and mass spectrometry according to one embodiment, wherein the device is formed chromatographic channels where chromatographic resins may be packed into the channel behind a constriction, interconnecting channels, valves, sample and buffer input ports, and a spray nozzle for mass spectrometry;

FIG. 2 is a schematic drawing of a valve mechanism of the device;

FIG. 3 is a schematic drawing showing one exemplary microfluidic device according to the present invention and an interface device for sample and buffer input;

FIG. 4 is a schematic drawing showing the microfluidic device according to the present invention and an interface device for sample and buffer input mated together;

FIG. 5 is a schematic drawing of the microfluidic device according to the present invention with capillaries of smaller channels inserted into the chromatographic channels to create chromatographic channels with smaller diameters that may not be accessible by injection molding, wherein in FIG. 5, a capillary has been inserted into the first and last chromatographic channels, respectively;

FIG. 6A is a schematic drawing of a conventional microfluidic channel with a rectangular cross-section and a “funnel-shape” constriction along the length of the channel;

FIG. 6B is a cross-sectional view taken along the line 6B-6B of FIG. 6A;

FIG. 6C is a cross-sectional view taken along the line 6C-6C of FIG. 6A;

FIG. 7 is a cross-sectional view of a conventional nozzle device;

FIG. 8 is a cross-sectional view of the nozzle device of FIG. 7 filled with chromatographic particles; and

FIG. 9 is a cross-sectional view of an array of nozzle devices of FIG. 7 contained within a chamber.

### DETAILED DESCRIPTION OF DIFFERENT EMBODIMENTS

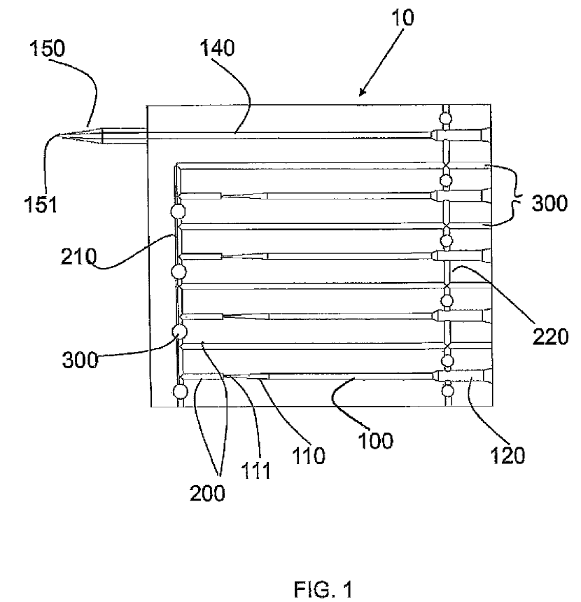

Referring to FIG. 1, one embodiment of the microfluidic device 10 is made of one piece of injection-molded plastic. The plastic may be any injection-moldable polymer. The preferred polymers are polyalkanes such as polyethylene, polypropylene, polybutylterephthalate, etc. Hard polymers such as ethylene-norbornene co-polymers, or polystyrene and its co-polymers can also be used. Embedded in the device 10 are chromatographic channels 100, vertical connecting channels 200 and horizontal connecting channels 210 at the distal ends of the chromatography channels, and horizontal connecting channels 220 that connect to the capillary receptacles 120. There are valves 300 which allow or disallow fluid to flow past a particular intersection of connecting channels. Each chromatographic channel 100 is open to the outside world through the capillary receptacle 120. All the channels are essentially cylindrical in shape and are without seams along its length. The channels are essentially cylindrical because from the open end of the channel to the closed end of the channel there may be a slight taper of 1 to 2 degrees due to the draft angle requirement in injection molding, although the taper angel may be larger to about 20 degrees. There may be from 1 to any number of chromatographic channels with their connecting channels in a device. The preferred number of chromatographic channels in a device is under 10.

The chromatographic channel 100 differs from the connecting channels 200, 210 and 220 in that it has a constriction 110 in one part of the channel. The general shape of the constriction 110 is conical. The diameter of the chromatographic channel may be from about 2000 μm to 100 μm and may vary along its length. The smaller is diameter of the chromatographic channel 100, the shorter is the length. For example, a 200 μm diameter chromatographic channel 100 may be as long as several centimeters, whereas the length of a 100 μm diameter chromatographic channel 100 may be only 1 mm long. The preferred diameters of the chromatographic channel are those that correspond to commercially available silica or polymeric capillaries, e.g., 360 μm. The conical shape channel 110 narrows from the diameter of the chromatography channel to the apex opening 111 of the cone which is from 10 to 30 microns in diameter. The preferred diameter of the conical apex opening 111 is about 20 μm. The conical angle may be in the range of about 3° to 30°. The preferred range is 5° to 12°. The conical apex opens into the connecting channel 200 except for the last chromatographic channel 140 of the device 10 which has the constriction 150 protrude beyond the edge of the device 10, and the conical apex opening 151 has an outside diameter in the range of 50 μm to 150 μm.

Each chromatographic channel 100 is open to the outside world from the opposite end of the conical apex opening 110 through the capillary receptacle 120. The capillary receptacle 120 has a diameter that is larger than or the same as the diameter of the chromatographic channel 100. The diameter of the capillary receptacle 120 is in the range of 150 μm to 5000 μm, and again the preferred diameters of the capillary receptacle 120 are those that correspond to commercially available silica or polymeric capillaries, e.g., 360 μm. If the diameter of the capillary receptacle 120 is larger than that of the chromatographic channel 100, the junction between the larger capillary receptacle and the smaller chromatographic channel may be tapered or abrupt, although a tapered junction is preferred. The length of the capillary receptacle 120 is from 1 to several mm. Chromatographic packing materials such as silica particles, polymer monoliths, nanoparticles, etc. can be readily and separately packed into each chromatographic channel 100 with methods known in the art through a tubing connected to the capillary receptacle 120. Each packed chromatographic channel 100 may perform a specific sample separation, cleanup or enrichment function different from those of the other chromatographic channels 100 in the same device.

The connecting channels 200, 210 and 220 have diameters that are not crucial but are preferably matching or are smaller than the diameter of the chromatographic channel. The horizontal connecting channels 210 intersect the vertical connecting channel 200 at the distal ends of the vertical channel 200 from the conical apex opening 111, and also the horizontal connecting channels 220 connect to the capillary receptacles 120.

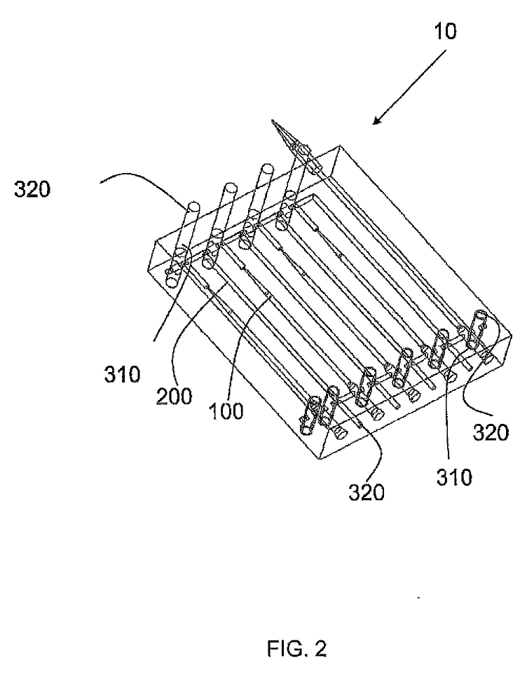

The valve 300 comprises of a hollow structure 310 along the length and perpendicular to the connecting channels 200, 210 or 220, and the valving mechanism is enabled by a rod or piston 320, or tubing of the same shape and size as the hole. The hole 310 can be of any smooth shapes, but a mostly cylindrical shape is preferred. Referring to FIG. 2, which is a perspective view of the device 10, when the cylindrical rod 320 is inserted into the cylindrical hole 310, fluid from one side of the connecting channel 200, 210 or 220 cannot flow through to the other side of the cylinder. In some cases, the cylindrical rod 320 may be left permanently in the cylindrical hole 310 as a means to make permanent separate sections of the connecting channels 200, 210 or 220. In this case, the cylindrical pistons 320 may not protrude beyond the surface of the device 10. Also the valves may be located on any side of the device 10.

Capillaries with the same diameter as the capillary receptacle can be inserted into the capillary receptacle 120 to seal the chromatographic channel to the outside world and from the intersecting horizontal connecting channel 220 and provides conduit of liquid to the chromatographic channel 10. Samples and buffers can flow through the capillaries into the chromatographic channel 100 with a pressure driven flow mechanism. Electrokinetic flow mechanism may also be used with appropriately placed electrodes, for example, through the valve pistons 320. When the capillaries inserted into the capillary receptacles 120 are pulled back a little beyond the intersections of the horizontal connecting channel 220, the chromatographic channels 100 can be connected by the connecting channels 200, 210 and 220 from the first one to the last in series. Likewise, with suitable arrangement of the valves and connecting channels, other configuration of the chromatographic channels 100, e.g., parallel, can be achieved. At the last chromatographic channel 140 in the device 10, the conical constriction 150 protrudes from the edge of the device 10 for a length of a few mm to a few cm. The apex 151 of the conical constriction 150 has an inside diameter about 20 μm and an outside diameter in the range of 50 to 150 μm. Liquid coming out of the conical apex 150 can be sprayed electrostatically by charging the liquid with a high electric field into the mass spectrometer for nanospray mass spectrometry detection. The liquid can also be sprayed on a MALDI plate for MALDI-mass spectrometry detection.

For an experiment with several analytes of interest in the sample, such as cancer biomarkers in blood serum, the device to be used will have the required number of chromatographic channels 100 prepacked with the appropriate resin and affinity agent in each channel. The serum sample will flow through each chromatographic channel 100 in turn; a special waste channel may be incorporated into one of the connecting channels that leads the spent serum to the outside world before it reaches the last chromatographic channel 140. The last chromatographic channel 140 may be packed with a resin that may separate the several biomarkers before mass spectrometry detection.

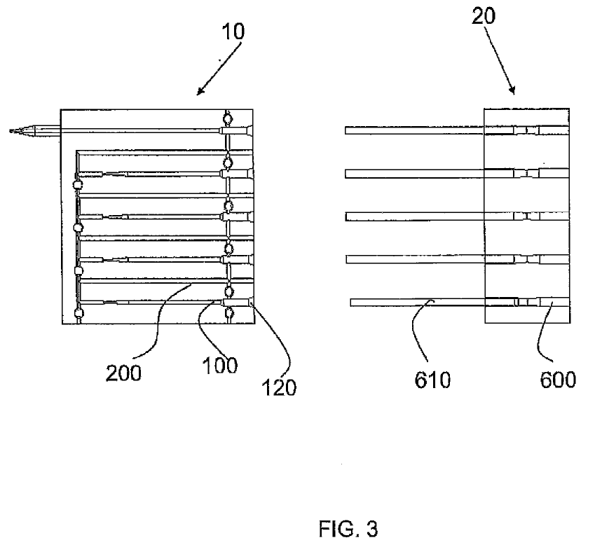

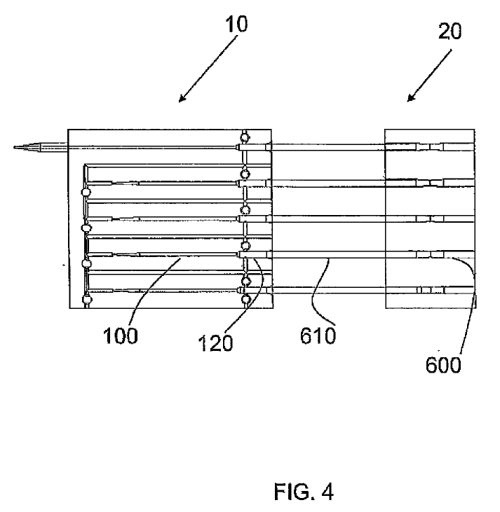

To facilitate the sample and buffer input into the device 10, it is convenient to have a liquid input interface device 20 that houses all the capillaries that can be inserted into the capillary receptacle of the device 10. In FIG. 3, an example of such an interface device 20 is shown being apart from device 10. The interface device 20 contains cylindrical through holes 600 that have the same inside diameter as the outside diameter of a silica or polymeric capillary and at the same spacing as the capillary receptacles 120 in the device 10. Capillaries 610 from a few mm to a few cm in length are inserted into the through holes to a depth of about half the length of the through holes 600. Capillaries (not shown) from the sample or buffer reservoirs may be inserted into the other side of the through holes 600 so that when the capillaries 610 have been inserted into the capillary receptacles 120, the samples and buffers can be pumped into the chromatography channels 100. In FIG. 4, the capillaries 610 of the interface device 20 are shown inserted into the capillary receptacles 120 of device 10. The device 20 shows that the capillaries 610 are inserted at the same time into the device 10. However, each of the capillaries 610 can be mounted in its own interface device so that the sample and buffers pumping can be individually controlled.

Depending on the amount and the kind of chromatographic materials packed in the chromatographic channels 100, it may be possible to dip the protruded conical nozzle 150 into the sample and apply suction at the capillary receptacle of the first chromatographic channel 100 to aspirate the sample through the nozzle opening 161 into the chromatographic channels 100 of the device 10 while the capillary receptacles 120 of all the other chromatographic channels 100 are sealed off. Another way to flow samples or buffers through the device is to deposit the sample or buffer into the first chromatographic channel 100 through the capillary receptacle 120 (which may be made large in diameter to accommodate a pipette tip or a syringe tip) and use a vacuum at the protruding nozzle 150 to vacuum the sample or buffer through all the chromatographic channels 100 to the outside world.

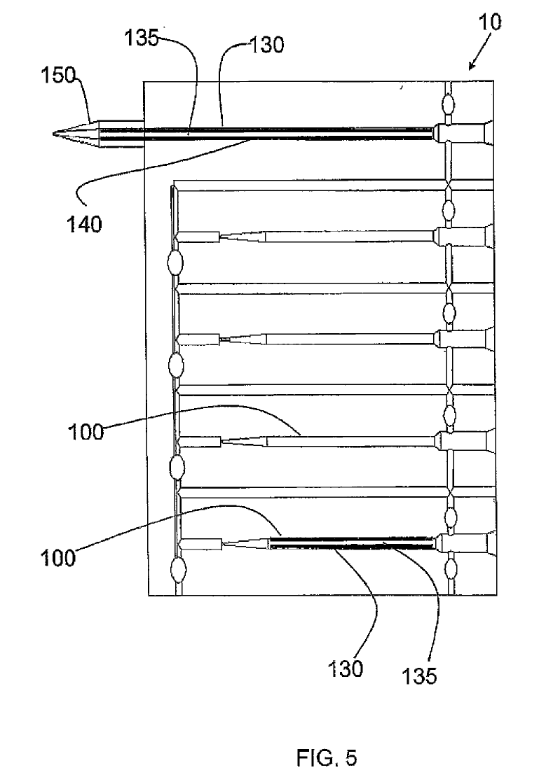

In another embodiment of the invention, shown in FIG. 5, a silica or polymeric capillary 130 with a small inside channel 135 with a diameter of, e.g., 75 μm, may be inserted into the chromatographic channel 100 so that the diameter of the chromatographic channel available for resin packing is that of the inside channel 135 of the capillary 130 instead of the diameter of the chromatographic channel 100. The requirement is that the outside diameter of the capillary 130 should be about the same as the inside diameter of the chromatographic channel 100. Since it may not be practical to injection-mold a 75 μm inside diameter chromatographic channel 100 for more than 1 mm long, this embodiment of the invention allows liquid chromatography in a several cm long capillary column to be performed in an integrated microfluidic device.

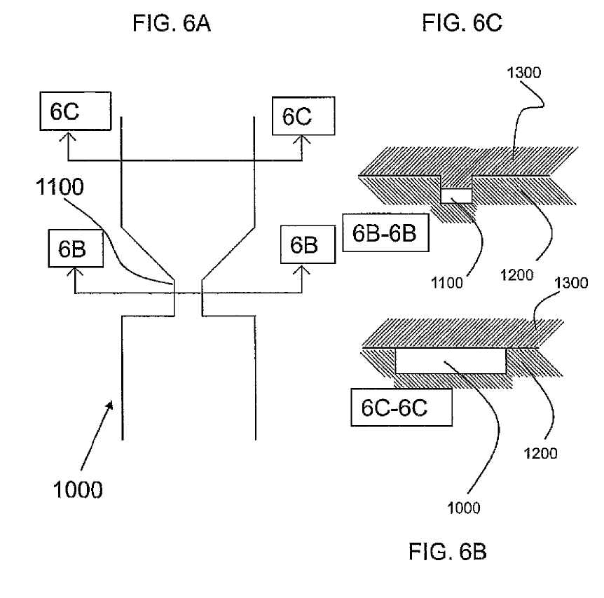

In still another embodiment of the invention shown schematically in FIGS. 6A-C, a conventional microfluidic channel 1000 with a rectangular cross-section has a “funnel-shape” constriction 1100 along the length of the channel. A well-established form in the art of the conventional channel is formed by two substrates, with a rectangular trough in the bottom substrate 1200 forming the channel proper and the top substrate 1300 forming the roof of the channel as shown in the cross sectional view 6C-6C in FIG. 6C. The size of the constriction opening 1110 is preferably less than 20 μm in both width and depth. If the microfluidic channel depth is more than 20 μm, then a protrusion 1310 from the top substrate 1300 may drop into the constriction area to reduce the depth of the channel to less than 20 μm, as shown in the cross-sectional view 6B-6B in FIG. 6B.

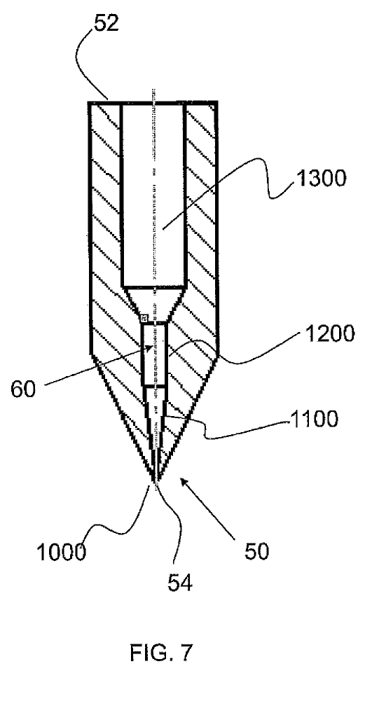

FIG. 7 is a cross section of an injection molded nozzle 50 that is described in detail in Applicant's U.S. Pat. Nos. 6,800,849; 6,864,480 and 6,969,850, each of which is hereby incorporated by reference in its entirety. The nozzle 50 includes an orifice 100 at the tip of the nozzle 50 and a channel that is formed in the nozzle and extends from a proximal end 52 to the orifice 1000 that is located at a distal end 54 of the nozzle 50. The nozzle 50 also includes a channel 60 that is formed therein and terminates at the distal end 54.

The channel 60 includes a number of different sections formed along its length. In particular, the channel 60 includes a conical microfluidic channel 1100 that connects the orifice 1000 to a straight portion 1200 (e.g., constant diameter or width) of the microfluidic channel 60, which opens into a reservoir 1300 that may have a capacity from a few microliters to tens of microliters or more. The channel 60 is thus formed between the reservoir 1300 and the orifice 1000 and serves to carry sample from the reservoir 1300 to the orifice 1000.

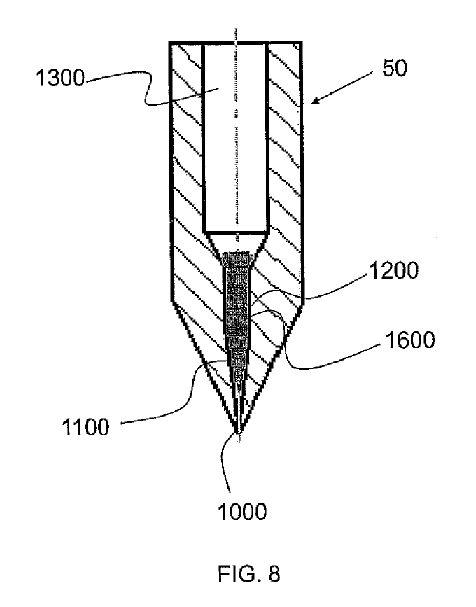

The specifications for the diameter of the nozzle orifice 1000 can be the same as those in the patents cited above, i.e., from 10 to 150 microns in diameter, with 15-25 microns being one preferred diameter range. The base of the conical microfluidic channel 60 is typically about 360 microns in diameter at least according to one embodiment. The length of the conical microfluidic channel portion 1100 is typically from about 0.9 mm to about 1.5 mm, but may be varied and can be from about 0.5 mm to about 2.5 mm. The straight portion 1200 of the microfluidic channel 60 can have a small incline angle of under 5 degrees to the vertical, and may be up to a few millimeters long. The inside surface of the reservoir 1300 can have an electrically conducting layer which can be an inert metal, such as gold or a conducting polymer. The end of the reservoir 1300 can be connected to a tapering cylindrical tube the distal end of which is designed to fit onto a pipette. Alternatively, the end of the reservoir 1300 can be connected by injection molding to a tapering cylindrical tube that fits onto a pipette, as exemplified in FIG. 21 of U.S. Pat. No. 6,864,480. The extension formed by the tapering cylindrical tube greatly increases the capacity of the reservoir 1300. In one embodiment shown in FIG. 8, the nozzle 50 and a part of the reservoir 1300 are filled with a chromatographic material 1600, such as silica particles from about 200 nanometers to about 15 microns in diameter, with one exemplary range of diameters being about 3 microns to about 5 microns in diameter. These particles are loose particles, i.e., they are not immobilized onto the inside walls of the nozzle 50 or the reservoir 1300, nor are they bonded to one another. These particles may be introduced into the nozzle 50 and the reservoir 1300 by pumping a slurry of the particles in suspension through the nozzle orifice 1000. Because of the tapering of the microfluidic channel 60 to the 20 micron diameter orifice 1000 of the nozzle 50, the particles, even the 3 micron diameter ones, are jammed inside the channels and do not leak through the nozzle opening to outside of the nozzle to any appreciable degree.

To prevent any leakage of the particles, a “frit” may be installed onto the opening of the nozzle 50 or the entrance to the microfluidic channel 60. The frit is a porous mechanical barrier to retain the chromatographic particles behind it. For micron size particles, a polymeric frit works well. In another embodiment of the invention, the chromatographic material is immobilized inside the microfluidic channel 60 of the nozzle 50 and can also be immobilized onto the wall of the reservoir 1300. The immobilized materials may contain silica particles from about 1 to about 15 microns in diameter immobilized by methods known in the art, or it can contain nanoparticles about 200 nm in diameter that self assemble to form a cohesive colloidal crystal so that the particles exhibit short and long range order, or it can be a polymer monolith that is formed by polymerizing monomers using a catalyst or an energy source such as light or heat. An example of a polymeric monolith suitable for chromatography is vinylbenzene copolymers.

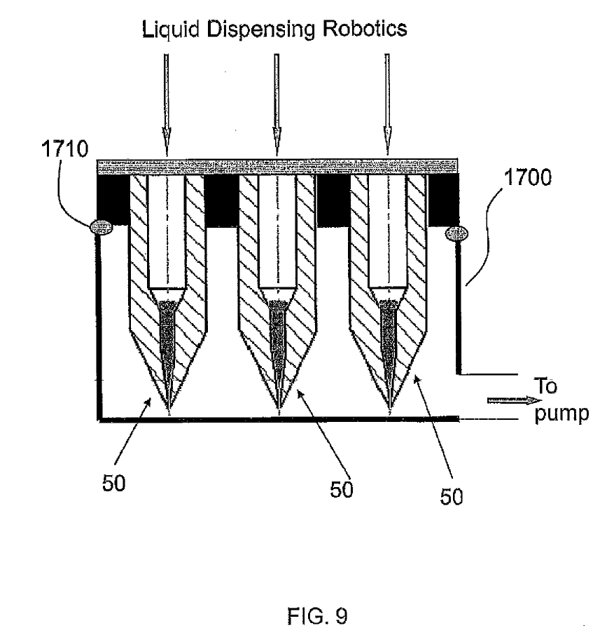

The present embodiment also includes a chamber 1700 where the nozzle devices, depicted in an array format, sit airtight over its sealing edges 1710 as shown in FIG. 9. When the chamber 1700 is being evacuated by a pumping mechanism connected to the chamber 1700, the liquid inside the reservoir 1300 will be forced through the microfluidic channel 60 filled with either the loose or immobilized chromatographic material out of the nozzle opening 1000 into the evacuation chamber 1700. Molecules in the liquid sample that have affinity with the chromatographic material stay on the chromatographic material and the rest drains away through the nozzle 50. In another embodiment, a pressurizing mechanism presses the liquid in the reservoir 1300 to pass through the chromatographic packing material so that the desired molecules are retained on the chromatographic material while the unwanted molecules and liquid drain out of the nozzle opening 1100. Examples of suitable pressurizing mechanisms are depicted in FIGS. 11, 12 and 13 in U.S. Pat. No. 6,864,480. High pressure nitrogen gas can also provide the pressurizing mechanism. In still another embodiment of the invention, both the evacuation chamber and the pressuring mechanism can be used simultaneous to enhance the draining of the sample.

The nozzle device and the evacuation chamber and pressuring mechanism may be multiplexed into an array, preferably compatible with the 96 and 384 formats.

### Example 1

An integrated chromatography-mass spectrometry device made of polypropylene as described in this application was used for affinity chromatography-mass spectrometry for the detection of transferrin in breast milk. The device contained two chromatographic channels, the second of which ended with the protruding nozzle used for mass spectrometry spraying. Before the experiment, a 360 μm outside diameter capillary was inserted into the capillary receptacle of the same diameter of the first chromatographic channel and a slurry of 5 μm C18 reverse phase silica particles in methanol was pumped at a pressure of about 600 psi into the first chromatographic channel. The chromatographic channel itself was 200 μm in diameter. The capillary receptacle at the opening of the second chromatographic channel was blocked with a 360 m diameter cylindrical polymeric rod. The C18 particles were trapped behind the constriction of the first chromatographic channel. Because the device had thin walls and the polypropylene is translucent, the length of particles packed into the chromatographic channel was readily observed and measured. The slurry was stopped when the length of the packed chromatographic particles reached 3 mm, which took less than 1 minute. The methanol from the flurry was drained through the constriction to the connecting channels into the second chromatographic channel and then to the outside through the protruding nozzle. The slurry capillary was removed, and a new one connected to a reservoir of wash solution of 50% water and 50% methanol was inserted in its place and the liquid was pumped for a few minutes through the packed and empty chromatographic channels, respectively, for the purpose of conditioning the C18 particles. A capillary connected to a reservoir containing an antibody anti-human transferrin in water was then connected to the capillary receptacle of the packed chromatographic channel after the previous wash capillary was removed. The sample containing the antibody was pumped slowly through the packed channel and the empty channel to the outside until sufficient amount of antibody was retained on the C18 5 micron particles. After rinsing the channels with the wash solution, then the channels were washed via capillary with phosphate buffer saline solution at pH=7.4 for a few minutes. Then a 20 mg/mL solution of bovine serum albumin (BSA) was pumped through a capillary to the packed resin and then through the channels so that the unused C18 sites on the silica particles were now taken by the albumin molecules. Again the channel was washed with the wash solution. Then 10 microliters of undiluted, unfiltered breast milk was pumped slowly via the capillary inserted in the capillary receptacle through the packed resin and out of the device. The transferrin molecules in the breast milk sample were expected to bind to the anti-human transferrin molecules on the silica particles. A silica capillary connected to a conducting union where a high voltage of 4 KV was applied to the liquid flowing through the union was then inserted into the capillary receptacle. The other side of the union was connected to another piece of silica capillary that was in turn connected to a syringe containing the eluting buffer, which was a 1% acetic acid solution in this case. The nozzle tip from the second chromatographic channel was positioned in front of the mass spectrometer inlet so that the nozzle opening pointed at an angle, preferably 90 degrees from the mass spectrometry inlet, and the high voltage charging the union was turned on. The off-axis placement of the nozzle opening with respect to the mass spectrometry inlet was to ensure that an occasional silica particle escaping from the nozzle opening would not enter the mass spectrometer. The 1% acetic acid in the syringe was placed in a syringe pump running at 500 nL/minute. As the acid carrying the transferrin molecules eluted from the nozzle at high voltage, the fine mist due to nanospray was formed. The transferrin molecules were efficiently ionized and analyzed by the mass spectrometer. Because of the concentration action of the silica particles, the transferrin molecules were now in high enough concentration to be detected by the mass spectrometer. The switching of capillaries carrying different buffers and samples were performed with robotics.

### Example 2

A nozzle device described in this application was attached to a pipette tip with the end cut off so that the opening of the tip fitted over the opening of the reservoir of the device in an air tight manner. The microfluidic channel behind the nozzle was pre-packed with 5 micron diameter C18 silica particles. The particle packing was achieved by inserting a silica capillary with a 360 micron outside diameter and a 75 micron inside diameter into the 360 micron diameter channel connecting the microfluidic channel behind the nozzle and the reservoir, and pumping a slurry of 5 micron diameter C18 particles in methanol through the capillary at about 600 pounds per squared inch (psi) pressure for a minute. When the nozzle device was taken off the capillary, the microfluidic channel and a part of the 360 micron diameter channel connecting to the reservoir was packed with the silica particles. The total volume of packed particles was about 0.1 microliter. The packed nozzle tip was immersed in a wash mixture of 50% water and 50% methanol. By aspirating the pipette, some wash liquid was sucked into the reservoir through the packed particles. The wash mixture was expelled into a waste container by compressing the pipette handle. The wash was repeated 5 times. The nozzle device tip was then placed in a microfuge tube containing an antibody anti-human transferrin in water. The same aspiration/expulsion cycle was carried out with anti-human transferrin, which acted as the affinity agent, solution until sufficient amount of antibody was retained on the C18 5 micron particles. After rinsing the nozzle tip in the wash solution, then the nozzle tip was dipped into a solution of phosphate buffer saline solution at pH=7.4 and the wash cycle was repeated three times. Then the nozzle device tip was dipped into the a 20 mg/mL solution of bovine serum albumin (BSA) and the aspirate/dispense cycle was carried out so that the unused C18 sites on the silica particles were now taken by the albumin molecules. Again the nozzle tip was rinsed in the wash solution. Then the nozzle tip was placed in 10 microliters of undiluted, unfiltered breast milk. Again the aspiration/dispensing cycle was repeated 10 times. The transferrin molecules in the breast milk sample were expected to bind to the anti-human transferrin molecules on the silica particles. A silica capillary with a 360 micron outside diameter and a 75 micron inside diameter was again inserted into the 360 micron diameter channel connecting to the microfluidic channel behind the nozzle. This capillary was connected to a conducting union where a high voltage of 4 KV was applied to the liquid flowing through the union. The other side of the union was connected to another piece of silica capillary that was in turn connected to a syringe containing the eluting buffer, which was a 1% acetic acid solution in this case. The nozzle tip was positioned in front of the mass spectrometer inlet so that the nozzle opening pointed at an angle, preferably 90 degrees from the mass spectrometry inlet, and the high voltage charging the union was turned on. The off-axis placement of the nozzle opening with respect to the mass spectrometry inlet was to ensure that an occasional silica particle escaping from the nozzle opening would not enter the mass spectrometer. The 1% acetic acid in the syringe was placed in a syringe pump running at 500 nL/minute. As the acid carrying the transferrin molecules eluted from the nozzle at high voltage, the fine mist due to nanospray was formed. The transferrin molecules were efficiently ionized and analyzed by the mass spectrometer. Because of the concentration action of the aspiration/dispensing cycles, the transferrin molecules were now in high enough concentration to be detected by the mass spectrometer.

### Example 3

An array of the nozzle devices as shown in FIG. 9 was placed on a chamber with a sealing mechanism such as an elastomeric o-ring and the chamber was connected to an evacuation mechanism such as a vacuum pump. A piercible silicone mat known in the art was placed on the array of nozzle device to cover and seal each reservoir. The nozzle array device and the chamber combination was placed on a platform that moved or agitated to provide some stirring action to the liquid sample placed inside each reservoir connected to each nozzle. Another stirring mechanism could be provided with a sonicator or a centrefuge. The same quantity of 5 micron C18 particles was placed into the reservoir of each nozzle device. The wash mixture from Example 2 was dispensed into each nozzle from the reservoir opening with a conventional robotic pipette tip. After some agitation from the moving platform, the pump connected to the evacuation chamber was turned on so that the wash mixture was suctioned out of the nozzle device through the nozzle opening. After draining the liquid from the reservoirs, the chamber was vented to air. The wash cycle was repeated five times. The same experiment as described in Example 2 was carried out in the same order. The only difference was that instead of the aspiration-dispensing cycle through the nozzle opening with a pipette, the process utilized robotic liquid dispensing into the reservoir through the piercible mat, followed by mechanical agitation and mixing, and then liquid evacuation from the reservoir trough the nozzle opening by vacuum action. Because of the array format, many different breast milk samples could be processed simultaneously using existing robotic liquid dispensing equipment. At the end of the sample preparation process, 1% acetic acid solution was dispensed into each reservoir, and the whole nozzle device array was placed in a three-dimensional robotic positioning system in front of the mass spectrometer preferably in the off axis position. A high voltage was applied to the reservoir through a gold coating that was covering the reservoir. A flow of nitrogen gas through the pierced mat pumped out the acid solution carrying the transferring molecules which were ionized by the high voltage for mass spectrometer analysis. After one nozzle finished spraying the eluting agent, the robotic positioning system carrying the nozzle device array moved the array to a different location so that another nozzle would be in position for spraying. The spraying procedure was repeated until all the nozzles in the array had sprayed the eluates into the mass spectrometer for analysis.

### Example 4

The nozzle device array was used for this experiment. Each nozzle device had immobilized surface-modified vinylbenzene polymers filling the microfluidic channel behind each nozzle and also the lower surface of the reservoir. The rest of the experiment was carried out as in Example 3.

### UTILITY

The integrated microfluidic device for liquid chromatography and mass spectrometry can be used in a clinical environment for the enrichment, separation and detection of multiple biomarkers in body fluids. The nozzle device and methods for both sample preparation and nanospray for mass spectrometry analysis can be used to concentrate desired disease biomarkers in body fluids that are minimally processed, and also be used to spray the desired biomarkers directly into the mass spectrometer for detection, or onto a MALDI plate for MALDI mass spectrometry detection. The nozzle device dramatically enhances the effectiveness of the sample cleanup processes because high surface area chromatographical materials can be used, and automation can be easily achieved.

What is claimed is:

1. A method for preparing a sample for injection into a mass spectrometer for analysis comprising the steps of:
forming an injection molded article that includes a body having a first surface and an opposing second surface, the body having at least one channel formed therein and extending through the body from the first surface to the second surface, wherein the channel has a reservoir section that is open at the first surface and a tapered section; and at least one nozzle disposed along the second surface and being in communication with the conical section, the nozzle being in fluid communication with the channel such that one end of the channel terminates in a nozzle opening that is formed as part of the nozzle, wherein the device is formed of an injection moldable material; and
filling the nozzle with chromatographic particles.

2. The method of claim 1, wherein the step of filling the nozzle includes filling the channel and the reservoir with the chromatographic particles.

3. The method of claim 1, wherein the chromatographic particles comprise silica particles that are immobilized within the nozzle.

4. The method of claim 3, wherein the particles are immobilized at least inside the channel and optionally within the reservoir.

5. The method of claim 1, wherein the chromatographic particles comprise loose particles that are free of immobilization within the nozzle.

6. The method of claim 1, wherein the tapered section comprises a conical section that terminates in the nozzle opening.

7. The method of claim 1, wherein the channel includes a constant diameter section between the reservoir and the tapered section.

8. The method of claim 1, wherein the step of filling the nozzle comprises the step of pumping a slurry of the chromatographic particles in suspension through the nozzle opening so that the slurry is disposed and contained within the channel and the reservoir.

9. The method of claim 1, further including the step of connecting an open end of the reservoir to a tapered cylindrically shaped tube the distal end of which is designed to mate with a pipette tip.

10. The method of claim 1, further including the step of connecting an open end of the reservoir to a tapered cylindrically shaped tube by an injection molding process, the tube being configured to mate with a pipette tip.

11. The method of claim 1, further including the step of:
disposing a frit along the nozzle so as to form a porous mechanical barrier to retain the chromatographic particle therebehind.

12. The method of claim 1, further including the steps of:
placing one or more injection molded articles within a chamber so as to form an array, wherein articles sit airtight over sealing edges of the chamber;
evacuating the chamber by a pumping mechanism connected to the chamber) wherein liquid within the reservoir is forced through the channel filled with the chromatographic particles and then out of the nozzle opening and into an inside of the chamber resulting in desired molecules being retained on the chromatographic particles while unwanted molecules and liquid drain out of the nozzle opening.

13. A method of analyzing a sample in a mass spectrometer comprising the steps of:
forming an injection molded article that includes a body having a first surface and an opposing second surface, the body having at least one channel formed therein and extending through the body from the first surface to the second surface, wherein the channel has a reservoir section that is open at the first surface and a tapered section; and at least one nozzle disposed along the second surface and being in communication with the conical section, the nozzle being in fluid communication with the channel such that one end of the channel terminates in a nozzle opening that is formed as part of the nozzle, wherein the device is formed of an injection moldable material;
filling the nozzle with chromatographic particles so that the particles are at least disposed within the channel and optionally also disposed within the reservoir;
positioning the nozzle opening in front of an inlet of a mass spectrometer device; and
filling the reservoir with sample liquid and forcing the liquid through the channel filled with the chromatographic particles and then out of the nozzle opening toward the mass spectrometer inlet.

14. The method of claim 13, further including the step of forming an electrically conducting layer on an inside surface of the reservoir and the step of forcing the liquid from the reservoir includes the step of applying a high voltage to the reservoir.

15. A microfluidic device comprising:
a substrate having a first end and an opposite second end and including:
a plurality of chromatographic channels formed therein, each of which terminates at the first end with a capillary receptacle that is open to the exterior, the chromatographic channel having a constricted section formed along its length at a first location;
packing material disposed within each chromatographic channel by inserting the packing material through the capillary receptacle and being retained therein by the presence of the constricted section which restricts movement of the packing material therein;
a plurality of interconnecting channels formed in the substrate and selectively providing communication between chromatographic channels; and
a plurality of valve members disposed in the substrate for selectively direct the flow of a fluid along channels formed in the substrate.

16. The microfluidic device of claim 15, wherein the device is a single injection molded article formed from an injection moldable polymer and the capillary receptacle has an outwardly tapered opening formed at the first end.

17. The microfluidic device of claim 15, wherein the interconnecting channels comprise a set of first channels that mate with an apex opening formed at a distal end of the constricted section; a set of second channels that selectively interconnect one first channel to another first channel; and a set of third channels that selectively interconnect one capillary receptacle to another capillary receptacle.

18. The microfluidic device of claim 17, wherein the second and third channels are formed perpendicular to the chromatographic channels, the plurality of valve members including a first set of valve members that are disposed through second channels that selectively prevent fluid flow within the second channels when the valve is in a closed position and a second set of valve member that are disposed through third channels that selectively prevent fluid flow within the third channels when the valve is in a closed position.

19. The microfluidic device of claim 18, wherein each valve member comprises an opening formed perpendicular to the interconnecting channels and dividing the interconnecting channel into two sections and a piston that is sealingly disposed within the opening such that in the closed position, the piston obstructs flow through the respective sections of the interconnecting channel and across the valve opening.

20. The microfluidic device of claim 15, wherein the chromatographic channels are connected in series as a result of the arrangement of the interconnecting channels and the valve members, the plurality of chromatographic channels including a last chromatographic channel that terminates in a constricted section that is located beyond the second end exterior to the substrate so as to define a spray nozzle.

21. The microfluidic device of claim 20, wherein the last chromatographic channel terminates in one end with the spray nozzle and at the other end with one capillary receptacle, the restricted section having a conical shape and terminating in an apex opening.

22. A nozzle device configured for sample concentration and for spraying for mass spectrometry analysis comprising:
an injection molded article that includes a body having a first surface and an opposing second surface, the body having at least one channel formed therein and extending through the body from the first surface to the second surface, wherein the channel has a reservoir section that is open at the first surface and a tapered section; and at least one nozzle disposed along the second surface and being in communication with the tapered section, the nozzle being in fluid communication with the channel such that one end of the channel terminates in a nozzle opening that is formed as part of the nozzle, wherein the device is formed of an injection moldable material; and
a porous polymeric material disposed at least within the channel and optionally within the reservoir, the porous polymeric material acting as chromatographic particles.

23. The nozzle device of claim 22, wherein the porous polymeric material is a polymer monolith that is formed by polymerized monomers using a catalyst or an energy source.

24. The nozzle device of claim 22, wherein the porous polymeric material comprises vinylbenzene that is suitable for chromatography.
